(19) United States
(12) Patent Application Publication
(10) Pub. No.: US 2025/0001600 A1
(43) Pub. Date: Jan. 2, 2025

(54) CONTROLLING MOVEMENT OF THIRD-PARTY ROBOTIC SYSTEMS ON AN INDUSTRIAL FLOOR WHILE EXECUTING A TRADE SECRET MANUFACTURING PROCESS

(71) Applicant: International Business Machines Corporation, Armonk, NY (US)

(72) Inventors: Fang Lu, Billerica, MA (US); Carolina Garcia Delgado, Zapopan (MX); Su Liu, Austin, TX (US); Sarbajit K. Rakshit, Kolkata (IN)

(21) Appl. No.: 18/342,771

(22) Filed: Jun. 28, 2023

(51) Int. Cl. B25J 9/16; H04L 9/00

(52) U.S. Cl. CPC B25J 9/1666; B25J 9/1676; H04L 9/50

(57) ABSTRACT

In an approach for creating a detection boundary within which a sensor capability of a third-party robotic machine is disabled to restrict the third-party robotic machine from capturing a propagation of one or more aspects of a manufacturing process, a processor evaluates a manufacturing process, wherein a feature of the manufacturing process is protected by a trade secret. A processor evaluates a sensor capability of a third-party robotic machine to detect an aspect of the manufacturing process. A processor determines a set of detection boundaries for the manufacturing process. A processor determines whether the sensor capability of the third-party robotic machine can be disabled. Responsive to determining the sensor capability of the third-party robotic machine can be disabled, a processor disables the sensor capability of the third-party robotic machine when the third-party robotic machine enters the set of detection boundaries for the manufacturing process.

### BACKGROUND OF THE INVENTION

The present invention relates generally to the field of manufacturing processes, and more particularly to use of a detection boundary for controlling movement of third-party robotic systems on an industrial floor while executing a trade secret manufacturing process.

Generally, any confidential information that provides a competitive edge for a business may be considered a trade secret. Unauthorized use of such information is regarded as an unfair trade practice and a violation of trade secret law. In most legal systems worldwide, protection of trade secrets is a component of the general concept of protection against unfair competition.

Trade secrets may include manufacturing, industrial, and commercial secrets. The subject matter of trade secrets is usually defined in broad terms and may include manufacturing processes, distribution methods, advertising strategies, sales methods, consumer profiles, and lists of suppliers and clients.

Unlike patents, trade secrets are protected without registration and other procedural formalities. Additionally, trade secrets are protected indefinitely. There are, however, some conditions that must be met for confidential information to be considered a trade secret. These conditions vary from country to country, but the general standards that exist among all countries include, but are not limited to, the information must be secret (i.e., not generally known among, or readily accessible to, circles that normally deal with the type of information in question); the information must have commercial value; and the information must have been subject to reasonable steps by the rightful holder of the information to keep it secret, such as through confidentiality agreements.

### SUMMARY

Aspects of an embodiment of the present invention disclose a method, computer program product, and computer system for creating a detection boundary within which a sensor capability of a third-party robotic machine is disabled to restrict the third-party robotic machine from capturing a propagation of one or more aspects of a manufacturing process while a performance of the manufacturing process is in progress. A processor evaluates a manufacturing process, wherein a feature of the manufacturing process is protected by a trade secret. A processor evaluates a sensor capability of a third-party robotic machine to detect an aspect of the manufacturing process. A processor determines a set of detection boundaries for the manufacturing process. A processor determines whether the sensor capability of the third-party robotic machine can be disabled. Responsive to determining the sensor capability of the third-party robotic machine can be disabled, a processor disables the sensor capability of the third-party robotic machine when the third-party robotic machine enters the set of detection boundaries for the manufacturing process to perform an activity.

In some aspects of an embodiment of the present invention, a processor identifies the aspect of the manufacturing process. A processor identifies an extent of a propagation of the aspect of the manufacturing process to a location on an industrial floor.

In some aspects of an embodiment of the present invention, the aspect of the manufacturing process is at least one of a visual aspect and a non-visual aspect.

In some aspects of an embodiment of the present invention, the set of detection boundaries for the manufacturing process are based on at least on one of the extent of the propagation of the aspect of the manufacturing process and the sensor capability of the third-party robotic machine to detect the aspect of the manufacturing process.

In some aspects of an embodiment of the present invention, the sensor capability of the third-party robotic machine can be disabled using blockchain integrated in the third-party robotic machine.

In some aspects of an embodiment of the present invention, responsive to determining the sensor capability of the third-party robotic machine cannot be disabled, a processor restricts the third-party robotic machine from accessing the set of detection boundaries for the manufacturing process.

In some aspects of an embodiment of the present invention, responsive to determining the sensor capability of the third-party robotic machine cannot be disabled, a processor reschedules a timeline for the third-party robotic machine to perform the activity within the set of detection boundaries.

In some aspects of an embodiment of the present invention, a processor instructs, by an ecosystem of the manufacturing process, the third-party robotic machine to relinquish system controls to the ecosystem, wherein the ecosystem provides instructions for performing the activity to the third-party robotic machine.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a robotic system movement control program, on a server within the distributed data processing environment of FIG. 1, in accordance with an embodiment of the present invention;

FIG. 3A and FIG. 3B are a set of diagrams illustrating a creation of a plurality of detection boundaries to protect a trade secret manufacturing process performed on an industrial floor from one or more third-party robotic machines, in accordance with an embodiment of the present invention; and

FIG. 4 depicts a block diagram of components of a computing environment representing the distributed data processing environment of FIG. 1, in accordance with an embodiment of the present invention.

### DETAILED DESCRIPTION

Embodiments of the present invention recognize that, on an industrial manufacturing floor, a manufacturing process is executed to manufacture one or more products. A step of the manufacturing process and/or an aspect of the manufacturing process may be protected by a trade secret. Embodiments of the present invention recognize that, during the manufacturing process, one or more aspects may be generated from a manufacturing machine involved in the manufacturing process. If a third-party robotic machine is deployed to perform work during the manufacturing process, it is possible for the third-party robotic machine to intercept a set of information related to the step of the manufacturing process and/or the aspect of the manufacturing process that may be protected by a trade secret. Therefore, embodiments of the present invention recognize a need for a system and method by which a third-party robotic machine may perform an activity but be limited to the set of information the third-party robotic machine may capture from the area where the trade secret manufacturing process is being executed.

Embodiments of the present invention provide a system and method to create a detection boundary within which a sensor capability of a third-party robotic machine is disabled to restrict the third-party robotic machine from capturing a propagation of one or more aspects of a manufacturing process while a performance of the manufacturing process is in progress. Prior to the manufacturing process beginning, the proposed system analyzes the manufacturing process workflow and the location of one or more steps of the workflow. Accordingly, the proposed system identifies which steps of the workflow need to be protected from third-party robotic machines for trade secret purposes. The proposed system then analyzes the presence of the third-party robotic machine on the manufacturing floor, a capability of the third-party robotic machine, and blockchain integrated into the third-party robotic machine that will permit disablement of a data capturing functionality of the third-party robotic machine. The proposed system analyzes one or more sensors installed around the manufacturing floor and tracks how far a visual aspect (e.g., smell, sound, temperature, airflow pattern generated from a manufacturing machine) is seen by a third-party robotic machine and how far a non-visual aspect is propagated. Accordingly, the proposed system identifies a type of sensor (e.g., thermal, visual, smell, sound) integrated in the third-party robotic machine that should be disabled so that the third-party robotic machine cannot capture a propagation of one or more aspects of the manufacturing machine.

The proposed system uses blockchain integrated into the third-party robotic machine to enable and disable a data capturing functionality of the third-party robotic machine when the third-party robotic machine is within or outside, respectively, an identified boundary where propagated information about the trade secret manufacturing process is available. If the third-party robotic machine needs to perform an activity while the trade secret manufacturing process is being executed, then the ecosystem of the manufacturing machines use an IoT feed to identify a type of activity to be performed and generate commands for the third-party robotic machine, so that, even though the data capturing functionality of the third-party robotic machine is disabled, the third-party robotic machine is controlled by the ecosystem of the manufacturing machines. If the configuration change (e.g., enabling and/or disabling the sensors) can't be done using blockchain integrated in the third-party robotic machine, the proposed system restricts the said third-party robotic machine from entering the identified boundary and/or will reschedule the activity timeline of the third-party robotic machine.

Implementation of embodiments of the present invention may take a variety of forms, and exemplary implementation details are discussed subsequently with reference to the Figures.

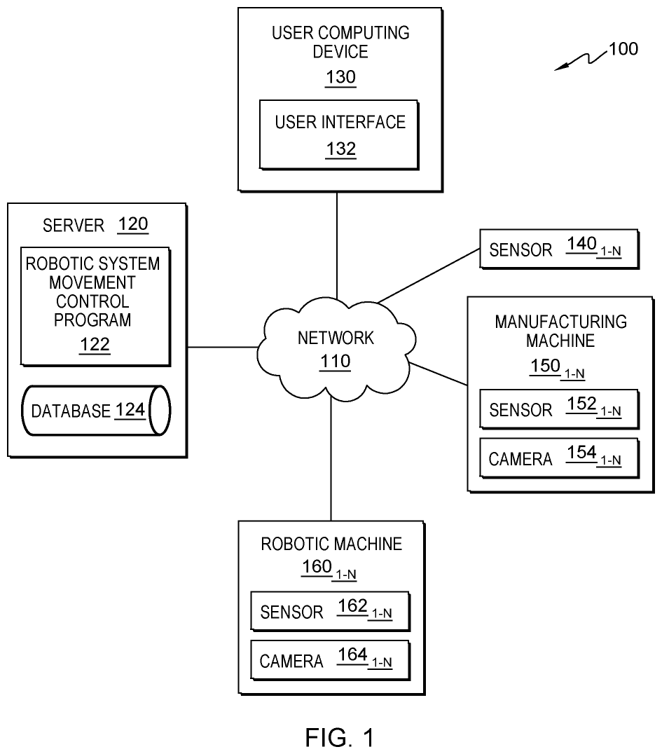

FIG. 1 is a block diagram illustrating a distributed data processing environment, generally designated 100, in accordance with an embodiment of the present invention. In the depicted embodiment, distributed data processing environment 100 includes server 120, user computing device 130, sensor 140_{1-N}, manufacturing machine 150_{1-N}, and robotic machine 1601-N, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, sensor 140_{1-N}, manufacturing machine 150_{1-N}, robotic machine 160_{1-N}, and other computing devices, sensors, manufacturing machines, and robotic machines (not shown) within distributed data processing environment 100.

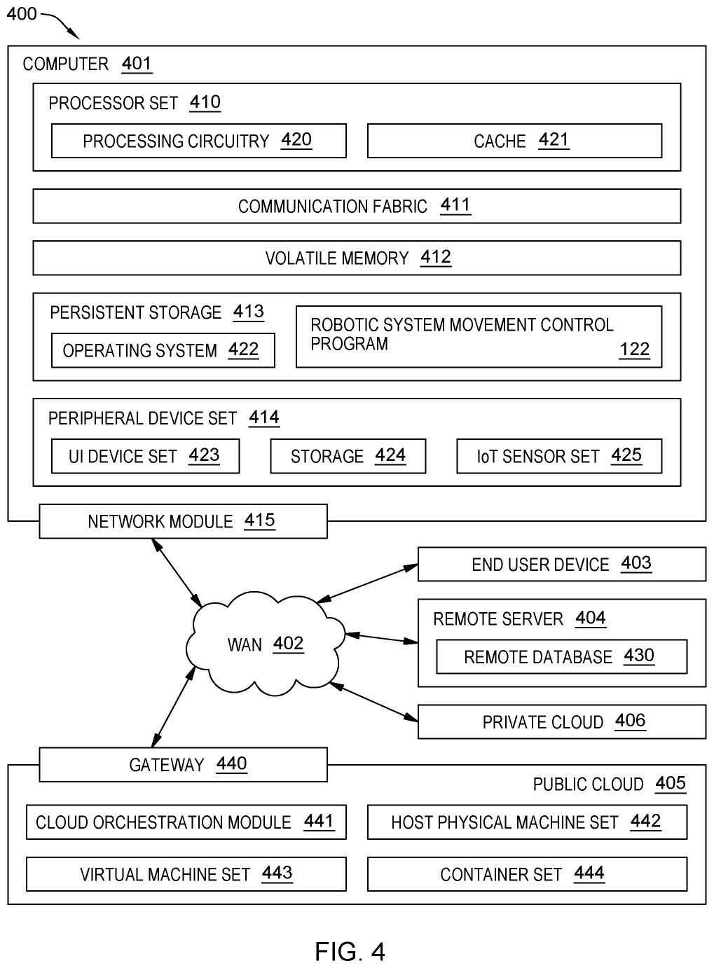

Server 120 operates to run robotic system movement control program 122 and to send and/or store data in database 124. In an embodiment, server 120 can send data from database 124 to user computing device 130, sensor 140_{1-N}, manufacturing machine 150_{1-N}, and robotic machine 1601-N. In an embodiment, server 120 can receive data in database 124 from user computing device 130, sensor 140_{1-N}, manufacturing machine 150_{1-N}, and robotic machine 160_{1-N}. In one or more embodiments, server 120 can be a standalone computing device, a management server, a web server, a mobile computing device, or any other electronic device or computing system capable of receiving, sending, and processing data and capable of communicating with user computing device 130, sensor 140_{1-N}, manufacturing machine 150_{1-N}, and robotic machine 160_{1-N} via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, sensor 140_{1-N}, manufacturing machine 150_{1-N}, robotic machine 160_{1-N}, and other computing devices, sensors, manufacturing machines, and robotic machines (not shown) within distributed data processing environment 100 via network 110. Server 120 may include internal and external hardware components, as depicted and described in further detail in FIG. 4.

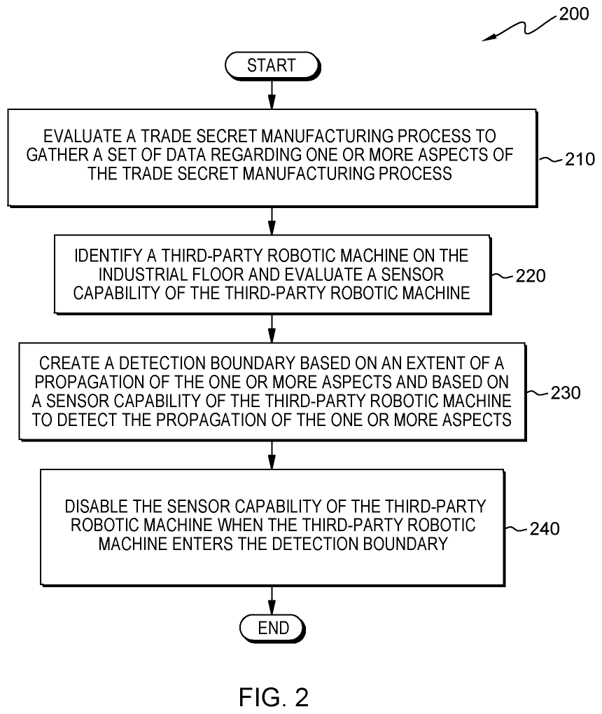

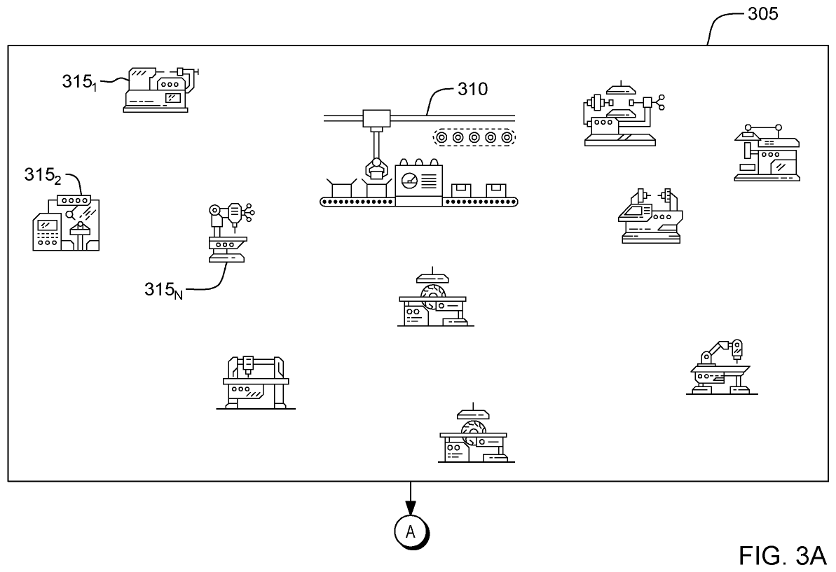

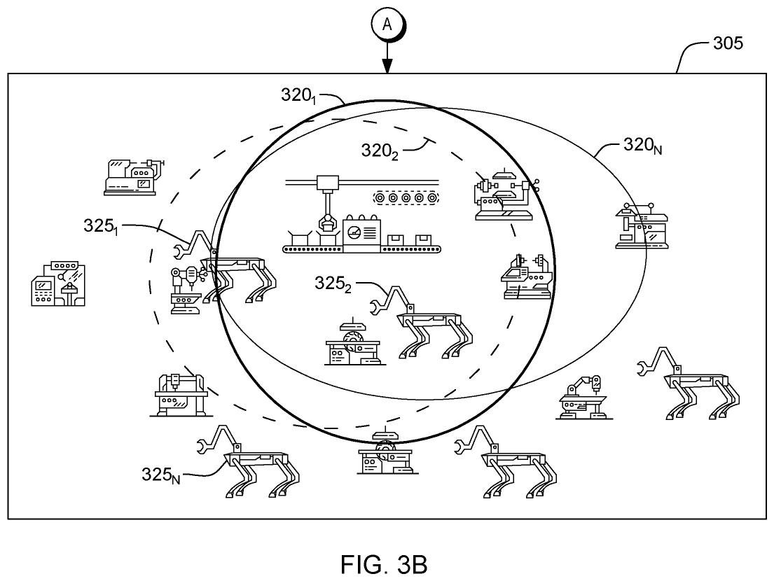

Robotic system movement control program 122 operates to create a detection boundary within which a sensor capability of a third-party robotic machine is disabled to restrict the third-party robotic machine from capturing a propagation of one or more aspects of a manufacturing process while a performance of the manufacturing process is in progress. In the depicted embodiment, robotic system movement control program 122 is a standalone program. In another embodiment, robotic system movement control program 122 may be integrated into another software product. In the depicted embodiment, robotic system movement control program 122 resides on server 120. In another embodiment, robotic system movement control program 122 may reside on another computing device (not shown), provided that robotic system movement control program 122 has access to network 110. The operational steps of robotic system movement control program 122 are depicted and described in further detail with respect to FIG. 2. An illustration of a creation of a plurality of detection boundaries to protect a trade secret manufacturing process performed on an industrial floor from one or more third-party robotic machines is depicted and described in further detail with respect to FIG. 3A and FIG. 3B.

In an embodiment, the user of user computing device 130 registers with robotic system movement control program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via robotic system movement control program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by robotic system movement control program 122. A database is an organized collection of data. Data includes, but is not limited to, information about user preferences (e.g., general user system settings such as alert notifications for user computing device 130); information about alert notification preferences; a set of historical information (e.g., a historical set of data about a same, a similar, and/or a different manufacturing process); a set of data regarding a manufacturing process (e.g., data regarding the manufacturing process; data regarding a manufacturing machine involved in the manufacturing process; data regarding a robotic machine involved in the manufacturing process; data regarding the industrial floor on which the manufacturing process occurs; and data regarding a feature of the manufacturing process protected by a trade secret); and any other data received, used, and/or generated by robotic system movement control program 122.

Database 124 can be implemented with any type of device capable of storing data and configuration files that can be accessed and utilized by server 120, such as a hard disk drive, a database server, or a flash memory. In an embodiment, database 124 is accessed by robotic system movement control program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that robotic system movement control program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Robotic system movement control program 122 enables the authorized and secure processing of personal data and/or confidential company data.

Robotic system movement control program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Robotic system movement control program 122 provides information regarding personal and/or confidential company data and the nature (e.g., type, scope, purpose, duration, etc.) of the processing. Robotic system movement control program 122 provides the user with copies of stored personal and/or confidential company data. Robotic system movement control program 122 allows the correction or completion of incorrect or incomplete personal and/or confidential company data. Robotic system movement control program 122 allows for the immediate deletion of personal and/or confidential company data.

User computing device 130 operates to run user interface 132 through which a user can interact with robotic system movement control program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with robotic system movement control program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between robotic system movement control program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from robotic system movement control program 122 to a user via network 110. User interface 132 can also display or present alerts including information (such as graphics, text, and/or sound) sent from robotic system movement control program 122 to a user via network 110. In an embodiment, user interface 132 can send and receive data (i.e., to and from robotic system movement control program 122 via network 110, respectively). Through user interface 132, a user can opt-in to robotic system movement control program 122; input information about the user; create a user profile; set user preferences and alert notification preferences; receive a request for feedback; and input feedback.

A user preference is a setting that can be customized for a particular user. A set of default user preferences are assigned to each user of robotic system movement control program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of robotic system movement control program 122.

Sensor 140_{1-N} operates to collect a set of data from the manufacturing process. As used herein, N represents a positive integer, and accordingly the number of scenarios implemented in a given embodiment of the present invention is not limited to those depicted in FIG. 1. In an embodiment, sensor 140_{1-N} is installed on the industrial floor. In an embodiment, sensor 140_{1-N} can receive data from server 120, user computing device 130, manufacturing machine 150_{1-N}, and robotic machine 160_{1-N}. In an embodiment, sensor 140_{1-N} can send data to server 120, user computing device 130, manufacturing machine 150_{1-N}, and robotic machine 160_{1-N}. In the depicted embodiment, sensor 140_{1-N} is a standalone device.

Manufacturing machine 150_{1-N} operates to transform a raw material into a completed product. As used herein, N represents a positive integer, and accordingly the number of scenarios implemented in a given embodiment of the present invention is not limited to those depicted in FIG. 1. Manufacturing machine 150_{1-N} may be operated automatically (e.g., by the manufacturing machine itself). Manufacturing machine 150_{1-N} may also be operated by, but is not limited to, one or more people and one or more robotic machines. The one or more robotic machines may be a third-party robotic machine and/or a non-third-party robotic machine. Throughout the manufacturing process, manufacturing machine 150_{1-N} generates and/or emits an aspect of the manufacturing process. The aspect of the manufacturing process generated and/or emitted may be, but is not limited to, a visual aspect and a non-visual aspect. The visual aspect may include, but is not limited to, a shape, a dimension, a color, a material, and a sequence of assembly of one or more products. The non-visual aspect may include, but is not limited to, a smell, a sound, a temperature, a vibration, and an airflow pattern generated and/or emitted during a stage of the trade secret manufacturing process. In an embodiment, manufacturing machine 150_{1-N} can receive data from server 120, user computing device 130, sensor 140_{1-N}, and robotic machine 160_{1-N}. In an embodiment, manufacturing machine 150_{1-N} can send data to server 120, user computing device 130, sensor 140_{1-N}, and robotic machine 160_{1-N}. In the depicted embodiment, manufacturing machine 150_{1-N} includes sensor 152_{1-N} and camera 154_{1-N}.

Sensor 152_{1-N} operates to collect a set of data from manufacturing machine 150_{1-N} and/or from a surrounding of manufacturing machine 150_{1-N} (e.g., from a performance of a manufacturing process in progress at and/or near manufacturing machine 150_{1-N}). As used herein, N represents a positive integer, and accordingly the number of scenarios implemented in a given embodiment of the present invention is not limited to those depicted in FIG. 1. In the depicted embodiment, sensor 152_{1-N} resides on manufacturing machine 150_{1-N}.

Camera 154_{1-N} operates to capture a still and/or moving picture within a 360-degree view of camera 154_{1-N}. As used herein, N represents a positive integer, and accordingly the number of scenarios implemented in a given embodiment of the present invention is not limited to those depicted in FIG. 1. In the depicted embodiment, camera 154_{1-N} resides on manufacturing machine 150_{1-N}.

Robotic machine 160_{1-N} operates to perform several manufacturing applications, including, but not limited to, material handling, processing operations, and assembly and inspection. As used herein, N represents a positive integer, and accordingly the number of scenarios implemented in a given embodiment of the present invention is not limited to those depicted in FIG. 1. In an embodiment, robotic machine 160_{1-N} can receive data from server 120, user computing device 130, sensor 140_{1-N}, and manufacturing machine 150_{1-N}. In an embodiment, robotic machine 160_{1-N} can send data to server 120, user computing device 130, sensor 140_{1-N}, and manufacturing machine 150_{1-N}. In the depicted embodiment, robotic machine 160_{1-N} includes sensor 162_{1-N} and/or camera 164_{1-N}.

Sensor 162_{1-N} operates to collect a set of data from robotic machine 160_{1-N} and/or from a surrounding of robotic machine 160_{1-N} (e.g., from a performance of a manufacturing process in progress at and/or near robotic machine 160_{1-N}). As used herein, N represents a positive integer, and accordingly the number of scenarios implemented in a given embodiment of the present invention is not limited to those depicted in FIG. 1. In the depicted embodiment, sensor 162_{1-N} resides on robotic system 160_{1-N}.

Camera 164_{1-N} operates to capture a still and/or moving picture within a 360-degree view of camera 164_{1-N}. As used herein, N represents a positive integer, and accordingly the number of scenarios implemented in a given embodiment of the present invention is not limited to those depicted in FIG. 1. In the depicted embodiment, camera 164_{1-N} resides on robotic machine 160_{1-N}.

FIG. 2 is a flowchart, generally designated 200, illustrating the operational steps for robotic system movement control program 122, on server 120 within distributed data processing environment 100 of FIG. 1, in accordance with an embodiment of the present invention. In an embodiment, robotic system movement control program 122 operates to create a detection boundary within which a sensor capability of a third-party robotic machine is disabled to restrict the third-party robotic machine from capturing a propagation of one or more aspects of a manufacturing process while a performance of the manufacturing process is in progress. It should be appreciated that the process depicted in FIG. 2 illustrates one possible iteration of the process flow, which may be repeated continually to ensure the trade secret manufacturing process is protected from a third-party robotic machine on an industrial floor.

In step 210, prior to a performance of the manufacturing process beginning (i.e., being in progress), robotic system movement control program 122 evaluates a manufacturing process. The manufacturing process may be performed by, but is not limited to, one or more people, one or more self-operating machines (e.g., manufacturing machine 150_{1-N}), and one or more robotic machines (e.g., robotic machine 160_{1-N}). The one or more robotic machines may be a third-party robotic machine and/or a non-third-party robotic machine. In progress may be, but is not limited to, when a product has begun the manufacturing process and is no longer included in a raw material inventory but is also not yet considered a completed product. In an embodiment, robotic system movement control program 122 evaluates a manufacturing process, wherein a feature of the manufacturing process is protected by a trade secret. In an embodiment, robotic system movement control program 122 evaluates a manufacturing process to gather a set of data regarding the manufacturing process. In an embodiment, robotic system movement control program 122 gathers a set of data regarding the manufacturing process. The set of data regarding the manufacturing process, for example, may include, but is not limited to, data regarding the manufacturing process; data regarding a manufacturing machine involved in the manufacturing process; data regarding a robotic machine involved in the manufacturing process; data regarding an industrial floor on which the manufacturing process occurs; and data regarding a feature of the manufacturing process protected by a trade secret. In an embodiment, robotic system movement control program 122 gathers a set of data regarding the manufacturing process from one or more sources. The one or more sources, for example, may include, but are not limited to, a sensor feed (e.g., a set of data collected from the manufacturing process) of a sensor (e.g., sensor 140_{1-N}) installed on the industrial floor, one or more people (e.g., via user computing device 130) involved in the manufacturing process; a manufacturing machine (e.g., via sensor 152_{1-N} and/or camera 154_{1-N} of manufacturing machine 150_{1-N}) involved in the manufacturing process; a robotic machine (e.g., via sensor 162_{1-N} and/or camera 164_{1-N} of robotic machine 160_{1-N}) involved in the manufacturing process; and a set of historical information (e.g., a historical set of data about a same, a similar, and/or a different manufacturing process) stored in a database (e.g., database 124). In an embodiment, robotic system movement control program 122 stores the set of data regarding the manufacturing process in a database (e.g., database 124). Data regarding the manufacturing process, for example, may include, but is not limited to, a workflow of the manufacturing process; an activity to be performed as a part of the manufacturing process (e.g., a relative location of the activity, a length of time of the activity, a frequency of times the activity is to be performed, whether the activity is protected by a trade secret, and, if the activity is protected by a trade secret, a configuration change to be applied to a third-party robotic machine so the third-party robotic machine may perform the activity but not capture data regarding the activity or the manufacturing process); a length of time of the manufacturing process; a frequency of times the manufacturing process is in progress; a product generated at the end of the manufacturing process; an amount of the product generated; an aspect generated and/or emitted from the manufacturing process; an amount of the aspect generated and/or emitted; and a input (i.e., gathering) and an output (i.e., sending) system. Data regarding a manufacturing machine (e.g., manufacturing machine 150_{1-N}) involved in the manufacturing process, for example, may include, but is not limited to, an identification of the manufacturing machine, a physical location of the manufacturing machine, a capability of the manufacturing machine, and a capacity of the manufacturing machine. Data regarding a robotic machine (e.g., robotic machine 160_{1-N}) involved in the manufacturing process, for example, may include, but is not limited to, an identification of the robotic machine, a physical location of the robotic machine, a capability of the robotic machine, and a capacity of the robotic machine. Data regarding the industrial floor on which the manufacturing process occurs, for example, may include, but is not limited to, data regarding an activity to be performed separate from the manufacturing process but in a surrounding area (e.g., a relative location of the activity to be performed separate from the manufacturing process but in a surrounding area and a period of time when the activity is to be performed separate from the manufacturing process but in a surrounding area) and a set of historical information about the same, a similar, and/or a different type of manufacturing process (e.g., a historical location and a historical feed of a sensor installed on the industrial floor of the similar type of manufacturing process). In an embodiment, robotic system movement control program 122 evaluates a manufacturing process to identify an aspect of the manufacturing process generated and/or emitted during the manufacturing process. The aspect of the manufacturing process generated and/or emitted may be, but is not limited to, a visual aspect and a non-visual aspect. The visual aspect may include, but is not limited to, a shape, a dimension, a color, a material, and a sequence of assembly of one or more products. The non-visual aspect may include, but is not limited to, a smell, a sound, a temperature, a vibration, and an airflow pattern generated and/or emitted during a stage of the trade secret manufacturing process. For example, robotic system movement control program 122 identifies one or more visual aspects and one or more non-visual aspects of a manufacturing process of a company protected by trade secrets. The one or more visual aspects and the one or more non-visual aspects protected by trade secrets may include, but are not limited to, one or more ingredients of a product, a scent of the product, a manufacturing process conducted to produce the product, and a manufacturing process conducted to produce the scent of the product. In an embodiment, robotic system movement control program 122 identifies a distance at which a visual aspect of the manufacturing process may be observed from a location on the industrial floor. In an embodiment, robotic system movement control program 122 identifies a distance to which a non-visual aspect of the manufacturing process may be propagated to a location on the industrial floor. In an embodiment, robotic system movement control program 122 identifies a pattern by which the non-visual aspect of the manufacturing process may be propagated (i.e., a propagation path). The distance to which the visual aspect is observed and the distance to which the non-visual aspect is propagated is measured in a basic unit (e.g., inch, foot, yard, mile) used by a local system (e.g., the international metric system, the English system, and British Imperial Measurement System).

In step 220, robotic system movement control program 122 identifies a third-party robotic machine (robotic machine 160_{1-N}) on the industrial floor. The third-party robotic machine may be used to perform a set of activities on the industrial floor, such as material removal, packaging, installation, overhauling, and cleaning of machines and floors. The third-party robotic machine may contain a sensor (e.g., sensor 162_{1-N}) (i.e., a data capturing functionality of the third-party robotic machine) and a camera (e.g., camera 164_{1-N}). The sensor installed in the third-party robotic machine may be one or more types including, but not limited to, a sensor that may detect a smell or an odor, a sensor that may detect a sound, a sensor that may detect a visual aspect, and a thermal sensor. The sensor and the camera installed in the third-party robotic machine may be used to identify a type of activity performed and a relative location on the industrial floor where the activity is performed. The sensor and the camera installed in the third-party robotic machine may be and can be selectively enabled and disabled from a remote location when necessary. In an embodiment, robotic system movement control program 122 evaluates a sensor capability of the third-party robotic machine. In an embodiment, robotic system movement control program 122 evaluates a sensor capability of the third-party robotic machine to detect the one or more aspects of the manufacturing process. In an embodiment, robotic system movement control program 122 determines whether the sensor capability of the third-party robotic machine needs to be disabled based on an ability of a sensor to detect one or more aspects of the manufacturing process. The sensor capability of the third-party robotic machine may need to be disabled so that the third-party robotic machine may not capture a set of information related to the manufacturing process. In an embodiment, responsive to determining the sensor capability of the third-party robotic machine needs to be disabled, robotic system movement control program 122 identifies a period of time (i.e., when) the sensor capability of the third-party robotic machine needs to be disabled. In an embodiment, responsive to determining the sensor capability of the third-party robotic machine needs to be disabled, robotic system movement control program 122 identifies a location (i.e., where) the sensor capability of the third-party robotic machine needs to be disabled.

In step 230, robotic system movement control program 122 creates a detection boundary. In an embodiment, robotic system movement control program 122 creates a detection boundary based on an extent of a propagation of the one or more aspects of the manufacturing process and based on a sensor capability of the third-party robotic machine to detect a propagation of the one or more aspects of the manufacturing process. The detection boundary is a virtual boundary. The virtual boundary is a virtual point or a virtual line (i.e., a set of virtual points) that mark one or more limits of an area. The virtual point or the virtual line (i.e., the set of virtual points) may be at a minimum distance to which the one or more aspects of the manufacturing process may propagate and/or at a maximum distance at which a sensor capability of the third-party robotic machine may detect the one or more aspects of the manufacturing process (i.e., a location where an aspect may be detected). For example, a detection boundary may be created at a step of a trade secret manufacturing process that needs to be protected for a trade secret reason. In an embodiment, robotic system movement control program 122 identifies a relative coordinate of the detection boundary created. In an embodiment, robotic system movement control program 122 identifies a set of activities the third-party robotic machine may perform within the detection boundary. In an embodiment, robotic system movement control program 122 identifies a set of activities the third-party robotic machine may perform within the detection boundary using one or more IoT feeds. In other words, robotic system movement control program 122 identifies a type of configuration change to be applied so that the third-party robotic machine may perform a set of activities on the industrial floor but may not capture a set of information related to the manufacturing process.

In step 240, responsive to a performance of the manufacturing process beginning, robotic system movement control program 122 disables the sensor capability (i.e., the data capturing functionalities) of the third-party robotic machine. In an embodiment, robotic system movement control program 122 disables the sensor capability of the third-party robotic machine using blockchain integrated in the third-party robotic machine. In an embodiment, robotic system movement control program 122 disables the sensor capability of the third-party robotic machine to restrict the third-party robotic machine from capturing a propagation of the one or more aspects of the manufacturing process within the detection boundaries while a performance of the manufacturing process is in progress. In an embodiment, robotic system movement control program 122 disables all input data connection systems. For example, if robotic system movement control program 122 does not want to have the third-party robotic machine learn a final version of a perfume smell, then robotic system movement control program 122 disables the smelling sensor capability of the third-party robotic machine before the third-party robotic machine reaches a pre-defined detection boundary on the industrial floor. Robotic system movement control program 122 determines what type of sensors should be disabled at what distance depending on a nature of a product generated and what type of trade secrets are to be protected. In another embodiment, responsive to determining the sensor capability of a third-party robotic machine cannot be disabled at the detection boundary using blockchain integrated in the third-party robotic machine, robotic system movement control program 122 restricts the third-party robotic machine from accessing an area within the detection boundaries. In another embodiment, responsive to determining the sensor capability of a third-party robotic machine cannot be disabled at the detection boundary using blockchain integrated in the third-party robotic machine but the third-party robotic machine must have access to an area within the detection boundaries, robotic system movement control program 122 reschedules a timeline for the third-party robotic machine to perform an activity in the area within the detection boundaries. In an embodiment, robotic system movement control program 122 generates commands for the third-party robotic machine. In an embodiment, robotic system movement control program 122 generates commands for the third-party robotic machine so that, even though the required sensors of the third-party robotic machine are disabled, the third-party robotic machine will be controlled by the manufacturing machines ecosystem while performing a set of activities. In an embodiment, robotic system movement control program 122 instructs the third-party robotic machine to relinquish system controls to the ecosystem. In an embodiment, robotic system movement control program 122 provides a set of instructions on how to perform the set of activities to the third-party robotic machine. In an embodiment, robotic system movement control program 122 captures a set of data from the surrounding of the third-party robotic machine. In an embodiment, robotic system movement control program 122 controls the third-party robotic machine to ensure the third-party robotic machine performs the activity and loses any external internet facing. In an embodiment, robotic system movement control program 122 enables the third-party robotic machine to perform the activity while the manufacturing process is carried out. In an embodiment, robotic system movement control program 122 reenables the sensor capability of the third-party robotic machine as necessary. In an embodiment, robotic system movement control program 122 reenables the sensor capability of the third-party robotic machine using blockchain integrated in the third-party robotic machine.

FIG. 3A and FIG. 3B depict a set of diagrams illustrating a creation of a plurality of detection boundaries to protect a trade secret manufacturing process performed on an industrial floor from one or more third-party robotic machines, on server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made. Prior to a performance of a manufacturing process (e.g., 310) beginning, robotic system movement control program 122 evaluates a manufacturing process (e.g., 310) on a manufacturing floor (e.g., 305). A feature of the manufacturing process (e.g., 310) is protected by a trade secret. The manufacturing process (e.g., 310) includes a plurality of manufacturing machines (e.g., 315₁, 315₂, and 315_{N}). During the manufacturing process (e.g., 310), the plurality of manufacturing machines (e.g., 315₁, 315₂, and 315_{N}) generate one or more aspects. The one or more aspects generated are visual aspects and non-visual aspects. Robotic system movement control program 122 gathers a set of data regarding the manufacturing process (e.g., 310). The set of data regarding the manufacturing process (e.g., 310) includes data regarding the manufacturing process (e.g., 310); data regarding the manufacturing machines (e.g., 315₁, 315₂, and 315_{N}) involved in the manufacturing process (e.g., 310); data regarding a third-party robotic machine (e.g., 325₁, 325₂, and 325_{N}) involved in the manufacturing process (e.g., 310); data regarding the industrial floor (e.g., 305) on which the manufacturing process (e.g., 310) occurs; and data regarding a feature of the manufacturing process (e.g., 310) protected by a trade secret. In an embodiment, robotic system movement control program 122 gathers a set of data regarding the manufacturing process (e.g., 310) from one or more sources. The one or more sources includes a sensor feed of a sensor installed on the industrial floor (e.g., 305), one or more people (e.g., via a user computing device) involved in the manufacturing process (e.g., 310); a manufacturing machine (e.g., 315₁, 315₂, and 315_{N}) involved in the manufacturing process (e.g., 310); a third-party robotic machine (e.g., 325₁, 325₂, and 325_{N}) involved in the manufacturing process (e.g., 310); and a set of historical information stored in a database. Based on an analysis of the set of data regarding the manufacturing process (e.g., 310) gathered from the one or more sources, robotic system movement control program 122 creates a plurality of detection boundaries (e.g., 320₁, 320₂, and 320_{N}) to where at least one aspect is propagated. Subsequent to the performance of the manufacturing process (e.g., 310) beginning, robotic system movement control program 122 disables the sensor capability of the third-party robotic machines (e.g., 325₁, 325₂, and 325_{N}) using blockchain integrated in the third-party robotic machines (e.g., 325₁, 325₂, and 325_{N}). Robotic system movement control program 122 disables the sensor capability of the third-party robotic machines (e.g., 325₁, 325₂, and 325_{N}) to restrict the third-party robotic machines (e.g., 325₁, 325₂, and 325_{N}) from capturing a propagation of the one or more aspects of the manufacturing process (e.g., 310) within the plurality of detection boundaries (e.g., 320₁, 320₂, and 320_{N}).

FIG. 4 depicts a block diagram, generally designated 400, of components of server 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing environment 400 contains an example of an environment for the execution of at least some of the computer code involved in performing the inventive methods, such as robotic system movement control program 122. In addition to robotic system movement control program 122, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and robotic system movement control program 122, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in robotic system movement control program 122 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface type operating systems that employ a kernel. The code included in robotic system movement control program 122 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
evaluating, by one or more processors, a manufacturing process, wherein a feature of the manufacturing process is protected by a trade secret;
evaluating, by the one or more processors, a sensor capability of a third-party robotic machine to detect an aspect of the manufacturing process;
determining, by the one or more processors, a set of detection boundaries for the manufacturing process;
determining, by the one or more processors, whether the sensor capability of the third-party robotic machine can be disabled; and
responsive to determining the sensor capability of the third-party robotic machine can be disabled, disabling, by the one or more processors, the sensor capability of the third-party robotic machine when the third-party robotic machine enters the set of detection boundaries for the manufacturing process to perform an activity.

2. The computer-implemented method of claim 1, wherein evaluating the manufacturing process further comprises:
identifying, by the one or more processors, the aspect of the manufacturing process; and
identifying, by the one or more processors, an extent of a propagation of the aspect of the manufacturing process to a location on an industrial floor.

3. The computer-implemented method of claim 1, wherein the aspect of the manufacturing process is at least one of a visual aspect and a non-visual aspect.

4. The computer-implemented method of claim 1, wherein the set of detection boundaries for the manufacturing process are based on at least on one of the extent of the propagation of the aspect of the manufacturing process and the sensor capability of the third-party robotic machine to detect the aspect of the manufacturing process.

5. The computer-implemented method of claim 1, wherein the sensor capability of the third-party robotic machine can be disabled using blockchain integrated in the third-party robotic machine.

6. The computer-implemented method of claim 1, further comprises:
responsive to determining the sensor capability of the third-party robotic machine cannot be disabled, restricting, by the one or more processors, the third-party robotic machine from accessing the set of detection boundaries for the manufacturing process.

7. The computer-implemented method of claim 1, further comprises:
responsive to determining the sensor capability of the third-party robotic machine cannot be disabled, rescheduling, by the one or more processors, a timeline for the third-party robotic machine to perform the activity within the set of detection boundaries.

8. The computer-implemented method of claim 1, furthering comprising:
instructing, by the one or more processors, by an ecosystem of the manufacturing process, the third-party robotic machine to relinquish system controls to the ecosystem, wherein the ecosystem provides instructions for performing the activity to the third-party robotic machine.

9. A computer program product comprising:
one or more computer readable storage media and program instructions stored on the one or more computer readable storage media, the program instructions comprising:
program instructions to evaluate a manufacturing process, wherein a feature of the manufacturing process is protected by a trade secret;
program instructions to evaluate a sensor capability of a third-party robotic machine to detect an aspect of the manufacturing process;
program instructions to determine a set of detection boundaries for the manufacturing process;
program instructions to determine whether the sensor capability of the third-party robotic machine can be disabled; and
responsive to determining the sensor capability of the third-party robotic machine can be disabled, program instructions to disable the sensor capability of the third-party robotic machine when the third-party robotic machine enters the set of detection boundaries for the manufacturing process to perform an activity.

10. The computer program product of claim 9, wherein evaluating the manufacturing process further comprises:
program instructions to identify the aspect of the manufacturing process; and
program instructions to identify an extent of a propagation of the aspect of the manufacturing process to a location on an industrial floor.

11. The computer program product of claim 9, wherein the set of detection boundaries for the manufacturing process are based on at least on one of the extent of the propagation of the aspect of the manufacturing process and the sensor capability of the third-party robotic machine to detect the aspect of the manufacturing process.

12. The computer program product of claim 9, further comprises:
responsive to determining the sensor capability of the third-party robotic machine cannot be disabled, program instructions to restrict the third-party robotic machine from accessing the set of detection boundaries for the manufacturing process.

13. The computer program product of claim 9, further comprises:
responsive to determining the sensor capability of the third-party robotic machine cannot be disabled, program instructions to reschedule a timeline for the third-party robotic machine to perform the activity within the set of detection boundaries.

14. The computer program product of claim 9, furthering comprising:
program instructions to instruct by an ecosystem of the manufacturing process, the third-party robotic machine to relinquish system controls to the ecosystem, wherein the ecosystem provides instructions for performing the activity to the third-party robotic machine.

15. A computer system comprising:
one or more computer processors;
one or more computer readable storage media;
program instructions collectively stored on the one or more computer readable storage media for execution by at least one of the one or more computer processors, the stored program instructions comprising:
program instructions to evaluate a manufacturing process, wherein a feature of the manufacturing process is protected by a trade secret;
program instructions to evaluate a sensor capability of a third-party robotic machine to detect an aspect of the manufacturing process;
program instructions to determine a set of detection boundaries for the manufacturing process;
program instructions to determine whether the sensor capability of the third-party robotic machine can be disabled; and
responsive to determining the sensor capability of the third-party robotic machine can be disabled, program instructions to disable the sensor capability of the third-party robotic machine when the third-party robotic machine enters the set of detection boundaries for the manufacturing process to perform an activity.

16. The computer system of claim 15, wherein evaluating the manufacturing process further comprises:
program instructions to identify the aspect of the manufacturing process; and
program instructions to identify an extent of a propagation of the aspect of the manufacturing process to a location on an industrial floor.

17. The computer system of claim 15, wherein the set of detection boundaries for the manufacturing process are based on at least on one of the extent of the propagation of the aspect of the manufacturing process and the sensor capability of the third-party robotic machine to detect the aspect of the manufacturing process.

18. The computer system of claim 15, further comprises:
responsive to determining the sensor capability of the third-party robotic machine cannot be disabled, program instructions to restrict the third-party robotic machine from accessing the set of detection boundaries for the manufacturing process.

19. The computer system of claim 15, further comprises:
responsive to determining the sensor capability of the third-party robotic machine cannot be disabled, program instructions to reschedule a timeline for the third-party robotic machine to perform the activity within the set of detection boundaries.

20. The computer system of claim 15, furthering comprising:
program instructions to instruct by an ecosystem of the manufacturing process, the third-party robotic machine to relinquish system controls to the ecosystem, wherein the ecosystem provides instructions for performing the activity to the third-party robotic machine.
